(19) United States
(12) Patent Application Publication
(10) Pub. No.: US 2010/0007952 A1
(43) Pub. Date: Jan. 14, 2010

(54) Arrangement for Adjusting and Compensating for First- and Second-Order Polarization Mode Dispersion

(75) Inventor: Peter Krummrich, Dortmund (DE)

Correspondence Address: LERNER GREENBERG STEMER LLP, P O BOX 2480, HOLLYWOOD, FL, 33022-2480, US

(73) Assignee: NOKIA SIEMENS NETWORKS GMBH & CO. KG, München (DE)

(21) Appl. No.: 12/442,716

(22) PCT Filed: Sep. 18, 2007
(86) PCT No.: PCT/EP2007/059834

§ 371 Date: Mar. 25, 2009

(30) Foreign Application Priority Data
Sep. 25, 2006 (DE) 10 2006 045 133.3

(51) Int. Cl. G02B 6/27

(52) U.S. Cl. 359/484

(57) ABSTRACT

A configuration contains a series connection of a first emulation element, having a first adjustable differential delay time between the fast and slow main axes and further having an adjustable chromatic dispersion of a polarization adjuster for the adjustment of a polarization rotation angle, and of a second emulation element, having a second adjustable delay time. Advantageously, the first and second differential delay times, the polarization rotation angle, and the chromatic dispersion can be adjusted by the configuration such that a desired value each is obtained for the differential group delay, the depolarization, and the polarization-dependant chromatic dispersion. By the adjustment of the chromatic dispersion, arbitrary frequency-dependant run times of the spectral components of a broadband optical input signal are generated. The configuration may also be utilized for the compensation of PMD of the first and second orders.

The invention relates to an arrangement and a method for adjusting first- and second-order polarization mode dispersion and to an arrangement for compensating for first- and second-order polarization mode dispersion.

Optical transmission systems for the long-distance domain currently use channel data rates of up to 10 Gbit/s. The commercial availability of routers with 40-Gbit/s interfaces presents the operators with the problem of having to transport signals at relatively high data rates. Since multiplexing down the router output signals would entail high costs and a high level of sophistication, the operators are looking for opportunities to transmit 40-Gbit/s signals in terrestrial long-distance networks. When designing the 40-Gbit/s network, the aim is to use optical fibers which have already been laid. These were produced many years ago and exhibit a high level of polarization mode dispersion (PMD for short) in comparison with freshly produced optical fibers. This has a lasting adverse effect on signal quality.

Polarization mode dispersion is a property of monomodal optical fibers, in which the energy in an optical input signal of a certain wavelength or carrier frequency is routed in the fiber in a mode which can arise in two polarizations which are orthogonal relative to one another. These two polarization states are frequently referred to as polarization modes or else as eigenstates or eigenmodes of the fiber. The polarization modes have different propagation speeds in the fiber on account of the voltage birefringence or on account of other irregularities in the refractive index. The resultant delay difference between the two orthogonal polarization modes upon passage through the fiber is referred to as differential group delay (DGD for short). Its mean value is called PMD delay Δτ and is given in the first order in ps.

In similar fashion to the chromatic dispersion, the PMD in optical transmission systems, particularly at high data rates, results in distortions in the pulse shape of the optical signal and additionally in transformation of the input polarization state. However, the PMD is a stochastic dynamic effect, which complicates both measurement and compensation. PMD varies as a function of time and wavelength. Firstly, the delay difference between the two polarization modes and particularly the polarization transformation property is sensitive to fluctuations in ambient conditions, such as temperature, mechanical stresses in the fiber or vibrations in the fiber, for example. This brings about irregular time variations in the response of the fiber. Secondly, the wavelength dependency causes both the eigenstates or polarization modes and the polarization state of the polarization modes to change on the basis of the wavelength in the optical signal. If the optical signal is a wideband signal, which is made up of a multiplicity of spectral components, then each spectral component sees a different birefringence and accordingly experiences a different delay and different polarization transformation by the fiber.

To take account of the wavelength dependency or the frequency dependency, a series expansion based on the frequency of the signal light is applied for the PMD. The frequency-independent first term of the series expansion is referred to as the first-order PMD and corresponds to the group delay difference for the two eigenmodes of the carrier frequency of the optical signal. The higher-order terms take account of the wavelength dependency or frequency dependency of the PMD. In the case of second-order PMD (SOPMD for short) a distinction is drawn between two forms: depolarization (DEP for short) and polarization-dependent chromatic dispersion (PCD for short). PCD causes the individual spectral components of the polarization modes of a pulse to diverge. DEP causes a change in the polarization of the individual spectral components. DEP partially depolarizes an originally polarized signal.

On account of the increased bandwidth of the optical signals at an increasing data rate, the higher-order PMD has an amplified effect at a data rate of 40 Gbit/s. For a section length of between several hundred km and just over 1000 km, PMD values are assembled which exceed the PMD tolerance of receivers available today by more than double. For error-free transmission, it is no longer sufficient to compensate for the first-order PMD. This means that when changing over to 40-Gbit systems there is an increasing requirement to compensate for higher-order PMD-related distortions too.

The literature discloses compensators for higher-order PMD whose control elements comprise a plurality of polarization controllers and a plurality of birefringent elements. However, regulation of these PMD compensators is found to be very difficult, because the relationship between the chosen settings for the polarization controllers and the resultant first- and second-order PMD of the control element is not known. This means that regulation is possible only with an iterative approach which involves a polarization controller being respectively adjusted in small steps.

Instead of iterative alignment, it is possible to perform direct adjustment of the PMD compensator control element in one step if the first- and second-order PMD has been measured beforehand at the output of the section using a polarimeter. For this purpose, the control element must allow the first- and second-order PMD to be adjusted in a specific manner. For the purpose of emulating the section PMD, laboratory instruments are known which allow the first- and second-order PMD to be adjusted in a specific manner, but not the split between the two forms of the second-order PMD. These instruments are therefore not suitable for use as a control element in a PMD compensator, since the two forms result in different signal distortions. Distortions in a signal as a result of PCD cannot be compensated for using a control element which has only DEP.

An earlier patent application with the application No. 10 2006 008 748.8 discloses an arrangement which comprises at least four series-connected birefringent elements, which, for a given carrier frequency, allows not only the adjustment of a desired first-order polarization mode dispersion but also separate adjustment of the depolarization and of the polarization-dependent chromatic dispersion. However, this arrangement is not suitable for wideband data signals such as are generated by means of NRZ or comparable modulation methods.

The European patent application EP 1 087 245 discloses a further arrangement for restricting first- and second-order polarization mode dispersion. The arrangement contains an element which compensates for the second-order PMD separately according to the causes thereof. The PCD and DEP are compensated for using a chirped fiber grid with a variable temperature gradient, an optical filter of complementary design with variable spectral transmission and a polarizer. The entire arrangement accordingly allows the specific adjustment of the first-order PMD and the second-order PMD even for wideband optical signals, the second-order PMD preferably being able to be adjusted separately according to its two forms DEP and PCD.

It is the object of the present invention to specify a further arrangement which allows specific adjustment of the first-order PMD and of the two forms of the second-order PMD for wideband optical signals.

This object is achieved by the features of patent claim 1.

Besides the adjustment of first-order PMD, separate adjustment of DEP and PCD is achieved for a wideband data signal by a series circuit comprising a first emulation element with a first adjustable delay difference between the fast and slow principal axes and with an adjustable chromatic dispersion, comprising a polarization controller for adjusting a polarization rotation angle and comprising a second emulation element with a second adjustable delay difference. Advantageously, the arrangement according to the invention can be used to adjust the first and second delay differences and/or the polarization rotation angle and/or the chromatic dispersion such that a desired value is obtained for the differential group delay (DGD) and/or the depolarization (DEP) and/or the polarization-dependent chromatic dispersion (PCD). The arrangement according to the invention is distinguished by its simplicity. In particular, the adjustment of the chromatic dispersion allows arbitrary frequency-dependent delays for the spectral components of a wideband optical input signal to be produced.

In one variant embodiment, both emulation elements have means for adjusting the chromatic dispersion. This allows the PCD to be split over both emulation elements. This is advantageous particularly when the chromatic dispersion which is produced within the first emulation element is not sufficient to adjust a desired PCD value on account of a limited adjustment range.

In one advantageous variant embodiment, the function of adjustable delay difference is provided by means of a variable birefringent element, and the function of adjustable chromatic dispersion is provided by means of a variable dispersion compensator.

Both functions can easily be combined if the birefringent element is in the form of a two-arm Mach-Zehnder interferometer arrangement, which have a beam splitter on the input side and a beam combiner on the output side. The beam splitter splits the input signal into two signal elements with orthogonal polarization relative to one another, which are then delayed differently and experience different chromatic dispersions.

Dependent on the variant embodiment, a variable dispersion compensator and a variable delay line are arranged either in one of the two subpaths or in both subpaths. It is also possible to accommodate a dispersion compensator in both paths and the delay line in just one path. It is also conceivable to have an arrangement comprising a dispersion compensator in one path and a delay line in the other path. This ensures flexible handling.

If both paths contain dispersion compensators with different arithmetic signs for the adjusted dispersion, it is advantageously possible to achieve symmetric distortion for the input signal.

If a means for level adjustment is inserted in at least one of the two subpaths, it is possible to prevent polarization-dependent losses.

The arrangement according to the invention can be used both for emulation and for compensation for PMD. In contrast to adaptive methods, the control element according to the invention is advantageously used to achieve compensation in one step. To this end, the PMD is determined using a high-resolution spectral polarimeter which is connected to a control unit. This takes the ascertained values as a basis for adjusting the arrangement according to the invention.

Further advantages of the invention are specified in the subclaims and the exemplary embodiments.

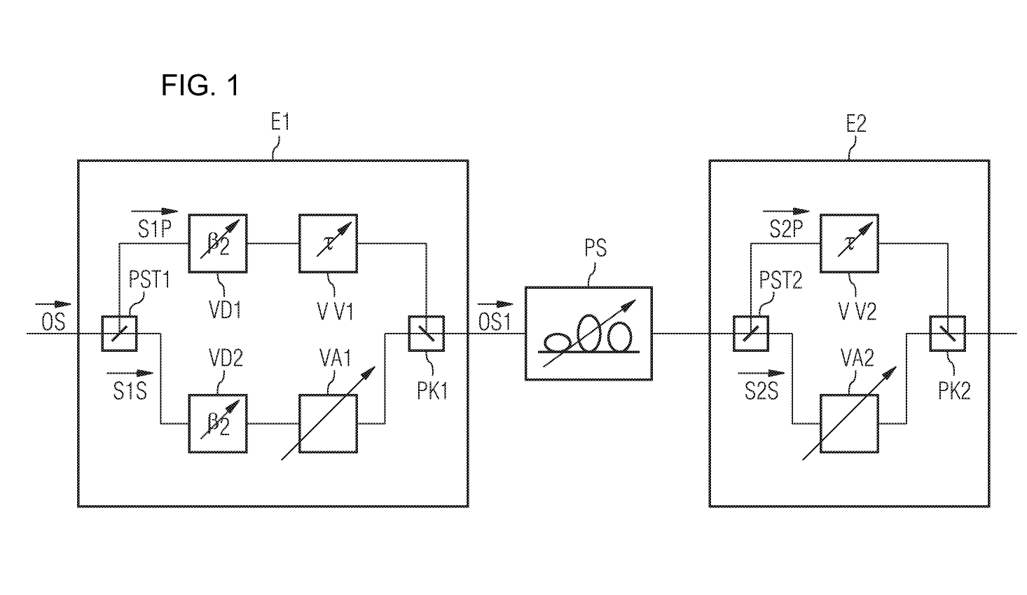

The invention is explained in more detail below with reference to FIGS. 1 to 4, in which:

FIG. 1 shows a block diagram of a first variant embodiment of the PMD emulator according to the invention,

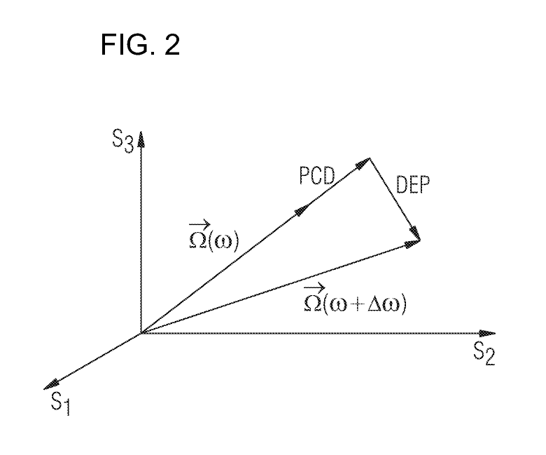

FIG. 2 shows an outline of a PMD vector in Stokes space to illustrate first- and second-order PMD,

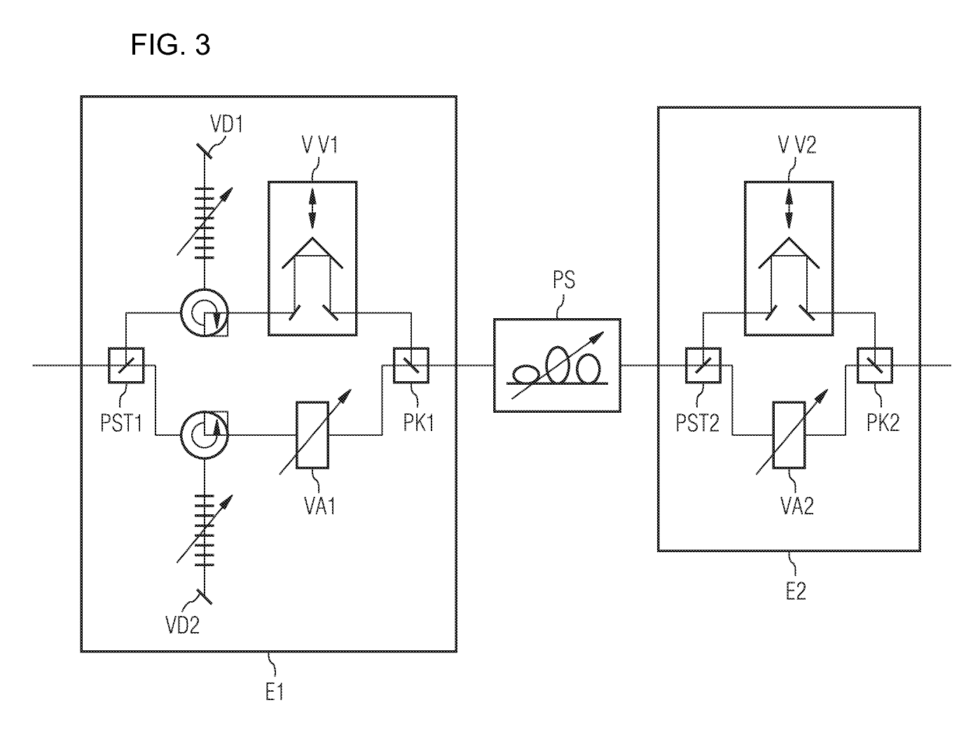

FIG. 3 shows a block diagram of a second variant embodiment of the PMD emulator according to the invention, and

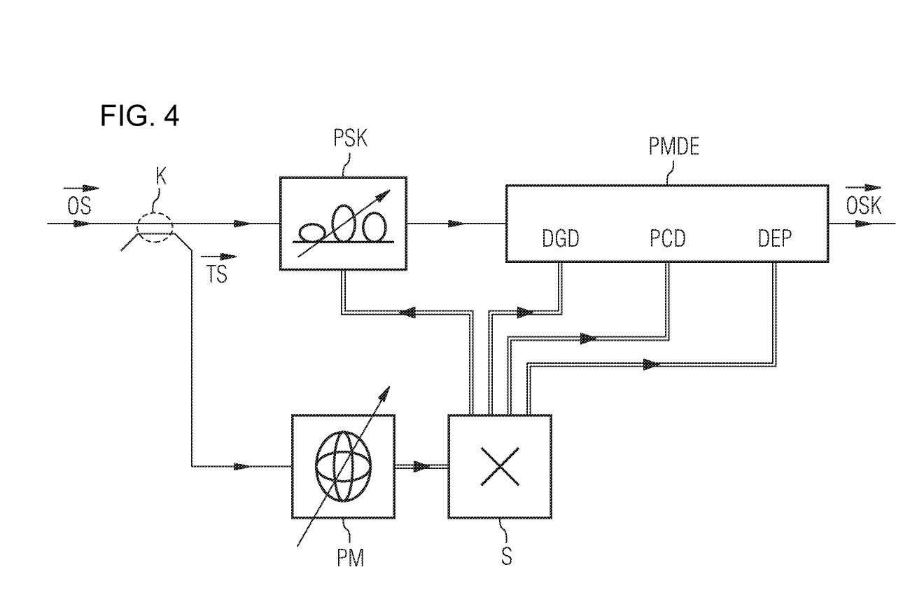

FIG. 4 shows a block diagram of a PMD compensator.

FIG. 1 shows a block diagram of a first variant embodiment of the inventive PMD emulator, which is constructed from a series circuit comprising a first emulation element E1, a polarization controller PS and a second emulation element E2. The first emulation element E1 corresponds to a birefringent element, whose DGD increases or decreases linearly over frequency and in which the DGD and the derivation of the DGD can be adjusted on the basis of frequency, i.e. the chromatic dispersion PCD. In this case, the second emulation element E2 is in the form of a dispersion-free adjustable linearly birefringent element, i.e. the adjusted DGD is frequency-independent.

An optical signal OS is supplied to the first emulation element E1. The optical signal OS is a wideband WDM signal, for example, which is composed from a multiplicity of intensity- or phase-modulated data signals. The data signals can be described in the frequency domain in line with Fourier's theorem by a spectrum of frequency or Fourier components with defined phases around a center frequency, the optical carrier frequency, i.e. the optical input signals occupy a particular frequency range or channel on the basis of data rate and modulation format.

The optical signal OS supplied to the emulator is split into two signal elements S1P and S1S with orthogonal polarization relative to one another at the input of E1 by a first polarization beam splitter PST1. In this exemplary embodiment, each of these two signal elements subsequently pass through a variable dispersion compensator VD1 or VD2. Alternatively, only one variable dispersion compensator may also be arranged in one of the paths. The dispersion compensators VD1 and VD2 are in this case used as dispersive elements, which are used to generate frequency-dependent delays for the individual frequency components of the optical signal for each polarization direction. The phase profile of the dispersion compensators is chosen such that the first and second derivations of the propagation constant β have different values after the frequency of zero, whereas higher derivations become negligibly small.

If the signal propagation is determined only by the first derivation of the propagation constant β on the basis of frequency, and higher derivations of the propagation constant on the basis of frequency are ignored, the phase of the data signal changes linearly with frequency, and the data signal itself is delayed for a certain period of time, referred to as the group delay. In this case, the signal shape remains unaltered. Signal distortion occurs only when the second derivation of the propagation constant β on the basis of frequency is taken into account. This signal distortion around the center frequency is referred to as group velocity dispersion (GVD for short) and is described by means of the GVD parameter β₂. Depending on the chosen arithmetic sign for the GVD parameter β₂, individual frequency components of the optical signal propagate more quickly or more slowly on the basis of frequency.

If a dispersion compensator is inserted in each path of E1, each of the two signal elements with orthogonal polarization relative to one another experiences a frequency-dependent change in the group delay. The dispersion compensator changes the phase of the data signal, for each data signal, quadratically as the distance from the center frequency increases, which corresponds to a linear change in the group delay. This means that for every polarization the differential group delay DGD can be modified on the basis of frequency. If the change in the DGD on the basis of frequency is chosen to be constant, the result is spectrally “flat” emulation of the PCD. For all carrier frequencies, the change in the group delay is then the same, or in other words the signal distortion is the same for every data signal in the wideband WDM signal. The third and further higher derivations of the propagation constant on the basis of frequency are negligible in this case.

The way in which the signal distortion is emulated is dependent on the design of the dispersion compensator. In particular, the distortion of the input signal is influenced by the choice of arithmetic sign for the GVD parameter of the dispersion compensator. If a respective dispersion compensator is accommodated in both paths of an emulation element, both signal elements are delayed on the basis of frequency and the signal resulting at the output of the emulation element is distorted symmetrically with respect to the frequency components. If a dispersive element is accommodated only in one path, the result is asymmetric distortion, because only one of the signal elements experiences a frequency-dependent delay.

The variable dispersion compensator can be provided using a tunable fiber Bragg grating in combination with a circulator, for example, by a virtually imaged phase array (VIPA), by coupled resonators or transversal filter with variable coefficients. Other implementation options are also conceivable.

Next, at least one of the signal elements S1S and S1P passes through a variable delay line VV1 of arbitrary design, which means that it is possible to adjust a differential delay difference Δτ₁ for the signal element passing through the upper path independently of the frequency compared to the signal element passing through the lower path. There are also numerous implementation options for producing arbitrary delay differences.

Furthermore, the lower path in this exemplary embodiment contains a variable attenuator VA1 which is used to allow the losses in both paths to be adjusted to the same magnitude, so that the same amplitudes are obtained at the end of the paths. Alternatively, elements for level adjustment can be provided in both paths. What is important is that both paths effectively have the same losses. The variable attenuators used should to this end be as polarization-independent and polarization-retentive as possible.

A second polarization beam splitter or a polarization combiner PK1 reassembles the two signal elements with orthogonal polarization to form a resultant signal OS1. At the output of the first emulation element E1, a distorted signal OS1 is obtained whose principal axis is rotated on average below 45°, provided that the same amplitudes of both signal elements are applied to the input of the polarization combiner. On account of the phase differences in both signal elements, the resultant polarization of OS1 is elliptical.

The signal OS1 then passes through a polarization controller PS which allows the polarization state obtained at the output of the first emulation element to be rotated with a variable angle of rotation α.

A second beam splitter PST2 splits the input signal for the second emulation element E2 into two orthogonal components again. A second variable delay line VV2 arranged in one of the two paths is used to produce a delay difference Δτ₂ between the two signal components independently of frequency. The second attenuator VA2, which in this exemplary embodiment is arranged in the lower path, is adjusted such that both signals have the same amplitudes upstream of the subsequent polarization combiner PK2. The second polarization combiner PK2 at the output of the second emulation element E2 reassembles the two polarizations.

To explain the way in which the arrangement from FIG. 1 works, FIG. 2 needs to be considered. PMD is frequently represented in the form of vectors in Stokes space. An overview of possible modes of representation or notations for describing PMD is provided by the publication by J. P. Gordon and H. Kogelnik, “PMD fundamentals: Polarization mode dispersion in optical fibers”, in Proc. Nat. Academy Science, Vol. 97, April 25, 200, pp. 4541-4550. A PMD vector combines the information about the direction of the fast and slow principal axes of a birefringent element, which are also referred to as principal axes of polarization (principal states of polarization, PSP for short) at the input and output of an element, and about the delay difference in the two polarization modes DGD, which is defined as the difference between the maximum and minimum speeds of the modes.

FIG. 2 shows two PMD vectors Ω in Stokes space at the angular frequencies ω and ω+Δω, wherein the relationship Δω<<ω applies for the frequencies. The small angular frequency change Δω means that both the length or standard and the direction of the original PMD vector change. The change in length is referred to as polarization-dependent chromatic dispersion PCD, and the change in direction is referred to as depolarization DEP. The change in frequency results in the new PMD vector Ω(ω+Δω). This means that both PCD and DEP can be produced solely by the change in frequency Δω.

The first part of the inventive arrangement upstream of the polarization controller can be described by means of a PMD vector whose direction is constant and whose length (PCD) increases and decreases linearly over frequency. The PCD can be adjusted using the variable dispersion compensator, and the length of the PMD vector or DGD Δτ₁ at the center frequency can be adjusted using the variable delay line.

Without the variable dispersion compensator, the arrangement in FIG. 1 would correspond to two birefringent elements with variable rotation of the fast principal axis of the second element in comparison with that of the first. The PMD vector resulting from the concatenation of the two birefringent elements has the following properties: the length or resultant DGD can be calculated using the following expression:

Δτ=\sqrt{Δτ₁²+2Δτ₁Δτ₂ cos(2α)+Δτ₂²}

in which Δτ₁ denotes the differential group delay of the first emulation element, Δτ₂ denotes that of the second emulation element and α denotes the angle through which the polarization controller rotates the direction of the polarization vector. The depolarization DEP can be calculated using the following expression:

DEP=Δτ_{1Δτ}₂ sin(2α)

PCD does not arise with two birefringent elements. In the arrangement according to the invention, the PCD can be adjusted using the variable dispersion compensator, and the DEP and DGD can be adjusted by suitable differential group delays Δτ₁, Δτ₂ and polarization rotation angles α. FIG. 3 shows a block diagram of a second variant embodiment of the inventive PMD emulator, in which both paths respectively accommodate a dispersion compensator comprising a tunable fiber Bragg grating in combination with a circulator. In this exemplary embodiment, the two variable dispersion elements VD1 and VD2 have respective different arithmetic signs for the adjustable dispersion. Thus, by way of example, the signal element S1P with parallel polarization relative to the incident plane experiences “positive” dispersion, in which, in the normal dispersion range, the high-frequency frequency components, what are known as “blue” frequency components, of the p-polarized signal propagate more slowly than the low-frequency ones, what are known as “red” frequency components, whereas the signal element S1S with orthogonal polarization relative to the incident plane experiences “negative” dispersion with the opposite effect. In this way, symmetric signal distortion is obtained at the output of the first emulation element.

The variable delay elements VV1 and VV2 in FIG. 3 are designed using bypass lines of adjustable length. The polarization controller PS is designed as a piezo fiber squeezer. Instead of a variable polarization controller, it is also possible to use one which brings about a fixed polarization rotation through a particular angle not equal to 0 degrees or integer multiples of 90 degrees. The DEP and DGD are then adjusted exclusively by means of the two differential group delays Δτ₁ and Δτ₂ upstream and downstream of the polarization controller PS.

To illustrate the invention further, a numerical example is provided for the block diagram shown in FIG. 3. The intention is to set a DGD of 10 ps, a PCD of 40 ps² and a DEP of 30 ps², in line with a total second-order PMD of 50 ps². To this end, a dispersion of +15.6 ps/nm is set on the dispersion element VD1 and a value of −15.6 ps/nm is set on the dispersion element VD2. The two bypass lines are adjusted such that a respective differential group delay of Δτ₁=ΔτT₂=5.83 ps is obtained. The polarization controller is set to an angle of rotation of 30.96 degrees.

In a further variant embodiment—which is not shown in FIGS. 1 and 3—a or a further dispersion compensator is arranged in one or both paths of the second emulation element E2 in addition to the dispersion compensator(s) of the first emulation element E1. In this way, two birefringent elements whose differential group delays (DGD) increase or decrease linearly over frequency are concatenated together.

The arrangement according to the invention can be used both for designing a PMD emulator with an adjustable PMD of first and spectrally flat second order, separated according to DEP and PCD, and for designing a PMD compensator. FIG. 4 shows a block diagram of a PMD compensator using the PMD emulator according to the invention. A coupler K branches off a small portion TS of the distorted optical input signal OS with an altered polarization state for control purposes. The optical input signal OS is then supplied to a polarization controller PSK and to the PMD emulator PMDE according to the invention. After passing through PMDE, the compensated signal OSK is output to the section again. The signal TS previously branched off on the coupler K is supplied to a high-resolution spectral polarimeter PM. The polarimeter measures the PMD at the output of the section on the basis of the frequency. The PMD vector ascertained in this manner at the output of the section has not only the absolute values of the DGD, the DEP and PCD but also a particular direction. This information is used within a control unit S downstream of the polarimeter to ascertain the delay differences Δτ₁, Δτ₂ and the polarization rotation angle α between the fast and slow principal axes of the birefringent elements in line with the provisions indicated above. The controller S is then used to adjust the angle of the polarization controller PSK and the absolute values of the DGD, PCD and DEP of the control element PMDE. The arithmetic signs of the DEP and PCD and the mapping of the signal at the output of the section into the emulator by the polarization controller PSK need to be chosen in this case such that the vectors of the emulator end up parallel in opposite directions with respect to those of the section. In this case, allowance must be made for the fact that the DEP is adjusted in the opposite direction to that of the section output. In addition, the absolute value of the PCD must have an opposite arithmetic sign in comparison with the section. This achieves compensation in one step. A slow and iterative procedure is avoided by means of the arrangement in FIG. 4.

1-10. (canceled)

11. A configuration for adjusting first-order and second-order polarization mode dispersion, comprising:
a series circuit containing:
a first emulation element with a first adjustable delay difference between a fast and a slow principal axis and with an adjustable chromatic dispersion;
a polarization controller for adjusting a polarization rotation angle and coupled to said first emulation element; and
a second emulation element with a second adjustable delay difference between the fast and the slow principal axis, said second emulation element coupled to said polarization controller;
wherein the first and second adjustable delay differences, the polarization rotation angle and the chromatic dispersion are adjusted such that a respective desired value is obtained for a differential group delay, a depolarization and a polarization-dependent chromatic dispersion.

12. The configuration according to claim 11, wherein said second emulation element has adjustable chromatic dispersion.

13. The configuration according to claim 11, wherein said first and second emulation elements are a combination of a variable birefringent element and at least one variable dispersion compensator.

14. The configuration according to claim 11, wherein said first and second emulation elements each have:
first and second subpaths;
an input side having a polarization beam splitter for splitting an input signal into two signal elements with orthogonal polarization relative to one another in said first and second subpaths;
an output side having a polarization combiner for combining the two signal elements and disposed downstream of said input side; and
a variable dispersion compensator and a variable delay line each disposed in at least one of said first and second subpaths.

15. The configuration according to claim 14, wherein said first subpath contains said variable dispersion compensator and said second subpath contains said variable delay line.

16. The configuration according to claim 14, wherein said variable dispersion compensator includes a first variable dispersion compensator and a second variable dispersion compensator, said first subpath contains said first variable dispersion compensator and said second subpath contains said second variable dispersion compensator, and said variable delay line is disposed in one of said first and second two subpaths.

17. The configuration according to claim 16, wherein when said first variable dispersion compensator is disposed in said first subpath and said second variable dispersion compensator is disposed in said second subpath, said first and second dispersion compensators have different arithmetic signs for an adjustable dispersion.

18. The configuration according to claim 14, wherein at least one of said first and second subpaths contains a means for level adjustment.

19. A configuration for compensating for first-order and second-order polarization mode dispersion, the configuration comprising:
an input side having a coupler with a first output and a second output;
a regulatable polarization controller connected to said first output of said coupler;
a configuration for adjusting first-order and second-order polarization mode dispersion connected to said regulatable polarization controller, said configuration for adjusting first-order and second-order polarization mode dispersion containing:
a series circuit containing:
a first emulation element with a first adjustable delay difference between a fast and a slow principal axis and with an adjustable chromatic dispersion;
a polarization controller for adjusting a polarization rotation angle and coupled to said first emulation element; and
a second emulation element with a second adjustable delay difference between the fast and the slow principal axis, said second emulation element coupled to said polarization controller;
wherein the first and second adjustable delay differences, the polarization rotation angle and the chromatic dispersion are adjusted such that a respective desired value is obtained for a differential group delay, a depolarization and a polarization-dependent chromatic dispersion;
a polarimeter connected to said second output of said coupler;
a control unit connected downstream of said polarimeter and takes directions and absolute values for the differential group delay which are measured by said polarimeter, said polarization-dependent chromatic dispersion and said depolarization as a basis for controlling said polarization controller and said configuration for adjusting first-order and second-order polarization mode dispersion.

20. A method for adjusting first-order and second-order polarization mode dispersion, which comprises the steps of:
in which for prescribed values of DGD, DEP and PCD on a basis of formulae DGD=\sqrt{Δτ₁²+2Δτ₁Δτ₂ cos(2α)+Δτ₂²} and DEP=Δτ₁Δτ₂ sin(2α), calculating values for a first delay difference Δτ₁ between a fast and a slow principal axis, for a second delay difference Δτ₂ between the fast and the slow principal axis and for an angle of rotation α for polarization;
using a first element for at least one of adjusting the first delay difference Δτ₁ and adjusting a polarization-dependent chromatic dispersion by splitting an input signal into a first and a second signal element with orthogonal polarization relative to one another, altering delays for at least one of the first and second signal elements on a basis of frequency and recombining the signal elements;
subsequently using a polarization controller to rotate a polarization of an output signal from the first element; and
using a second element to adjust the second delay difference Δτ₂, so that the first-order and second-order polarization mode dispersions are adjusted, separated according to depolarization and polarization-dependent chromatic dispersion, with the DEP and the PCD having a spectrally flat profile.
